(19) United States
(12) Patent Application Publication
(10) Pub. No.: US 2008/0247193 A1
(43) Pub. Date: Oct. 9, 2008

(54) Lamp that is assembled and disassembled easily and quickly

(75) Inventor: Keen Hsu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: Dong Guan Bright Yinhuey Lighting Co., Ltd., Dong Guan Township Humen Town (CN)

(21) Appl. No.: 11/732,751

(22) Filed: Apr. 4, 2007

(51) Int. Cl. H01R 33/02

(52) U.S. Cl. 362/650

(57) ABSTRACT

A lamp includes a lamp body, a threaded mounting seat, a threaded catch sleeve, a locating slide, a connecting member, and a lamp pole unit. The catch sleeve is rotatable relative to the mounting seat to push the locating slide toward the mounting seat and to move the male connector toward the female connector so that the male connector is connected to the female connector to form an electrical connection of the lamp. Thus, the male connector is not rotatable relative to the female connector when the male connector is movable relative to the female connector to prevent the first electric cords of the female connector and the second electric cords of the male connector from being distorted or tangled with each other.

### BACKGROUND OF THE INVENTION

1. Field of the Invention

The present invention relates to a lamp and, more particularly, to a lamp, such as a table or a pendant lamp.

2. Description of the Related Art

A conventional lamp comprises an adjustable clamp mounted on a table to attach the lamp onto the table, an arm having a lower end swivelably mounted on the adjustable clamp, a socket mounted on an upper end of the arm, an electric bulb mounted in the socket, and a shade mounted on the socket to cover the electric bulb. Thus, the electric bulb emits light outwardly to provide an illuminating effect. However, the conventional lamp has a fixed structure so that the composing parts of the lamp are not detachable, thereby causing inconvenience in packaging, storage and transportation of the lamp.

### BRIEF SUMMARY OF THE INVENTION

In accordance with the present invention, there is provided a lamp, comprising a lamp body, at least one threaded mounting seat mounted on the lamp body, at least one threaded catch sleeve screwed onto the mounting seat, at least one locating slide limited between the mounting seat and the catch sleeve and movable relative to the mounting seat by rotation of the catch sleeve relative to the mounting seat, at least one connecting member extended through the catch sleeve and having a first end secured to the locating slide and a second end protruding from the catch sleeve, and at least one lamp pole unit mounted on the second end of the connecting member.

The primary objective of the present invention is to provide a detachable lamp whose composing parts are assembled and disassembled easily and quickly.

Another objective of the present invention is to provide a lamp, wherein the catch sleeve is rotatable relative to the mounting seat to push the locating slide toward the mounting seat and to move the male connector toward the female connector so that the male connector is electrically connected to the female connector to form an electrical connection of the lamp.

A further objective of the present invention is to provide a lamp, wherein the locating slide is limited by the mounting bore of the catch sleeve so that the locating slide is movable with the catch sleeve, while the locating slide is rotatable in the mounting bore of the catch sleeve when the catch sleeve is rotatable relative to the mounting seat so that the locating slide is not rotatable with the catch sleeve when the catch sleeve is rotatable relative to the mounting seat.

A further objective of the present invention is to provide a lamp, wherein the male connector is not rotatable with the catch sleeve so that the male connector is not rotatable relative to the female connector when the male connector is movable relative to the female connector to prevent the first electric cords of the female connector and the second electric cords of the male connector from being distorted or tangled with each other.

A further objective of the present invention is to provide a lamp, wherein the catch sleeve is screwed onto or unscrewed from the mounting seat to connect or disconnect the male connector and the female connector so that the lamp is assembled and disassembled easily and quickly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a lamp in accordance with the preferred embodiment of the present invention.

FIG. 2 is a partially exploded perspective view of the lamp as shown in FIG. 1.

FIG. 3 is a partially perspective view of the lamp as shown in FIG. 1.

FIG. 4 is a perspective view of a lamp in accordance with another preferred embodiment of the present invention.

FIG. 5 is a partially perspective view of the lamp as shown in FIG. 5.

FIG. 6 is a partially exploded perspective view of the lamp as shown in FIG. 5.

### DETAILED DESCRIPTION OF THE INVENTION

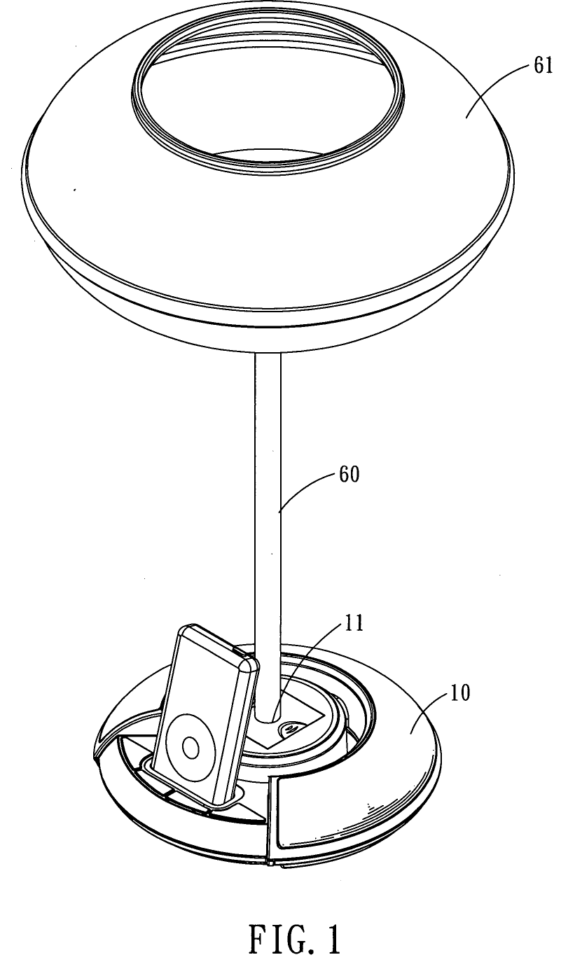

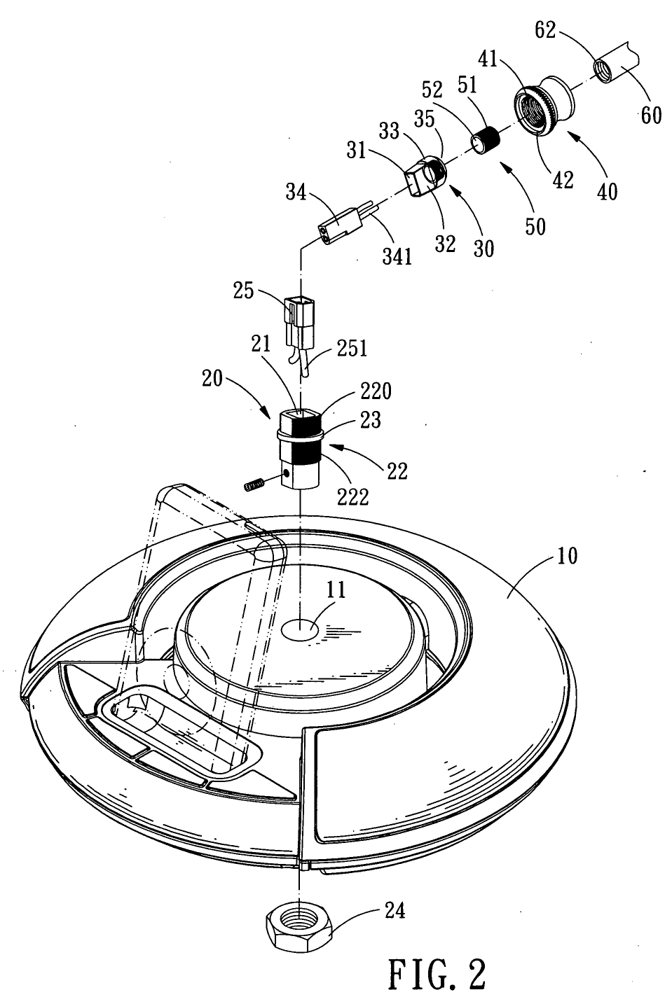

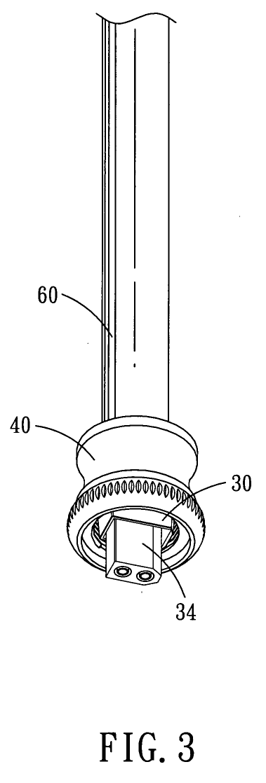

Referring to the drawings and initially to FIGS. 1-3, a lamp in accordance with the preferred embodiment of the present invention comprises a lamp body 10, a threaded mounting seat 20 mounted on the lamp body 10, a threaded catch sleeve 40 screwed onto the mounting seat 20, a locating slide 30 limited between the mounting seat 20 and the catch sleeve 40 and movable relative to the mounting seat 20 by rotation of the catch sleeve 40 relative to the mounting seat 20, a connecting member 50 extended through the catch sleeve 40 and having a first end secured to the locating slide 30 and a second end protruding from the catch sleeve 40, and a lamp pole unit 60 mounted on the second end of the connecting member 50. The lamp further comprises a female connector 25 mounted in the mounting seat 20, and a male connector 34 mounted in the locating slide 30 and movable by the locating slide 30 to contact the female connector 25 so that the male connector 34 is electrically connected to the female connector 25.

The lamp body 10 is formed with a mounting hole 11 for mounting the mounting seat 20.

The mounting seat 20 has an inner wall formed with a receiving hole 21 and an outer wall formed with an outer thread 22. The receiving hole 21 of the mounting seat 20 has a substantially rectangular shape and is extended through a whole length of the mounting seat 20. The outer thread 22 of the mounting seat 20 has a first end formed with a first threaded portion 220 protruding from a first side of the lamp body 10 and a second end formed with a second threaded portion 222 protruding from a second side of the lamp body 10. The outer thread 22 of the mounting seat 20 has a mediate portion formed with a radially and outwardly extending limit flange 23 located between the first threaded portion 220 and the second threaded portion 222 and rested on the first side of the lamp body 10. A locking nut 24 is screwed onto the second threaded portion 222 of the outer thread 22 of the mounting seat 20 and rested on the second side of the lamp body 10 so that the lamp body 10 is clamped between the limit flange 23 of the mounting seat 20 and the locking nut 24 to secure the mounting seat 20 to the lamp body 10.

The catch sleeve 40 has an inside formed with a substantially circular mounting bore 41 which has a peripheral wall formed with an inner thread 42 screwed onto the first threaded portion 220 of the outer thread 22 of the mounting seat 20 so that the catch sleeve 40 is rotatable relative to the mounting seat 20 to push the locating slide 30 to move relative to the mounting seat 20.

The locating slide 30 is rotatable freely in the catch sleeve 40 when the catch sleeve 40 is rotatable relative to the mounting seat 20. The locating slide 30 has an inside formed with a receiving bore 31 which is extended through a whole length of the locating slide 30. The locating slide 30 has a first end formed with a substantially rectangular locating post 32 which is movable in the receiving hole 21 of the mounting seat 20 to move the male connector 34 relative to the female connector 25 and a second end formed with a column 33 which is rotatable in the mounting bore 41 of the catch sleeve 40 when the catch sleeve 40 is rotatable relative to the mounting seat 20. The column 33 of the locating slide 30 has an inside formed with a screw bore 35 connected to the receiving bore 31 and the mounting bore 41 of the catch sleeve 40.

The female connector 25 is mounted in the receiving hole 21 of the mounting seat 20 and provided with two first electric cords 251, and the male connector 34 is mounted in the receiving bore 31 of the locating slide 30 to move with the locating slide 30 and provided with two second electric cords 341 that are electrically connected to the first electric cords 251 of the female connector 25 when the male connector 34 is movable to contact the female connector 25.

The connecting member 50 is extended through the mounting bore 41 of the catch sleeve 40 and has an inner wall formed with a passage 52 to allow passage of the second electric cords 341 of the male connector 34 and an outer wall formed with an outer threading 51 having a first portion screwed into the screw bore 35 of the column 33 of the locating slide 30 and a second portion protruded from the mounting bore 41 of the catch sleeve 40.

The lamp pole unit 60 has a first end formed with a screw hole 62 screwed onto the second portion of the outer threading 51 of the connecting member 50 and a second end provided with a light source 61 which is connected to the second electric cords 341 of the male connector 34. The second electric cords 341 of the male connector 34 are extended through an inside of the lamp pole unit 60.

In assembly, referring to FIGS. 1-3, when the inner thread 42 of the catch sleeve 40 is screwed onto the first threaded portion 220 of the outer thread 22 of the mounting seat 20, the catch sleeve 40 is rotatable relative to the mounting seat 20 to push the locating slide 30 toward the mounting seat 20 and to move the male connector 34 toward the female connector 25 so that the male connector 34 is electrically connected to the female connector 25 to form an electrical connection of the lamp. At this time, the locating slide 30 is limited by the mounting bore 41 of the catch sleeve 40 so that the locating slide 30 is movable with the catch sleeve 40, while the locating slide 30 is rotatable in the mounting bore 41 of the catch sleeve 40 when the catch sleeve 40 is rotatable relative to the mounting seat 20 so that the locating slide 30 is not rotatable with the catch sleeve 40 when the catch sleeve 40 is rotatable relative to the mounting seat 20. Thus, the male connector 34 is movable with the locating slide 30 and is not rotatable with the catch sleeve 40 so that the male connector 34 is not rotatable relative to the female connector 25 when the male connector 34 is movable relative to the female connector 25 to prevent the first electric cords 251 of the female connector 25 and the second electric cords 341 of the male connector 34 from being distorted or tangled with each other.

Accordingly, the catch sleeve 40 is rotatable relative to the mounting seat 20 to push the locating slide 30 toward the mounting seat 20 and to move the male connector 34 toward the female connector 25 so that the male connector 34 is electrically connected to the female connector 25 to form an electrical connection of the lamp. In addition, the locating slide 30 is limited by the mounting bore 41 of the catch sleeve 40 so that the locating slide 30 is movable with the catch sleeve 40, while the locating slide 30 is rotatable in the mounting bore 41 of the catch sleeve 40 when the catch sleeve 40 is rotatable relative to the mounting seat 20 so that the locating slide 30 is not rotatable with the catch sleeve 40 When the catch sleeve 40 is rotatable relative to the mounting seat 20. Further, the male connector 34 is not rotatable with the catch sleeve 40 so that the male connector 34 is not rotatable relative to the female connector 25 when the male connector 34 is movable relative to the female connector 25 to prevent the first electric cords 251 of the female connector 25 and the second electric cords 341 of the male connector 34 from being distorted or tangled with each other. Further, the catch sleeve 40 is screwed onto or unscrewed from the mounting seat 20 to connect or disconnect the male connector 34 and the female connector 25 so that the lamp is assembled and disassembled easily and quickly.

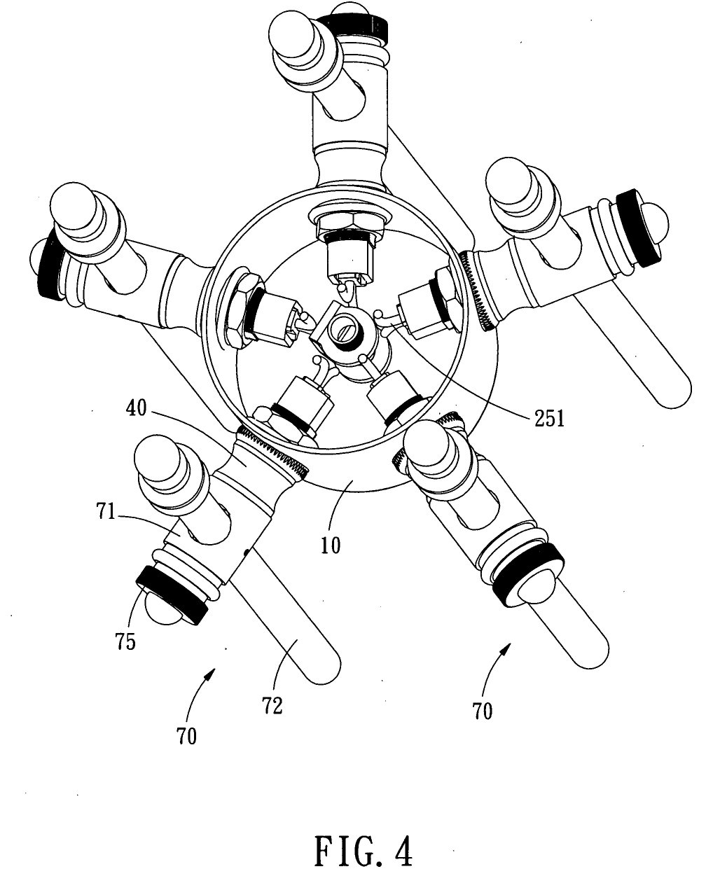

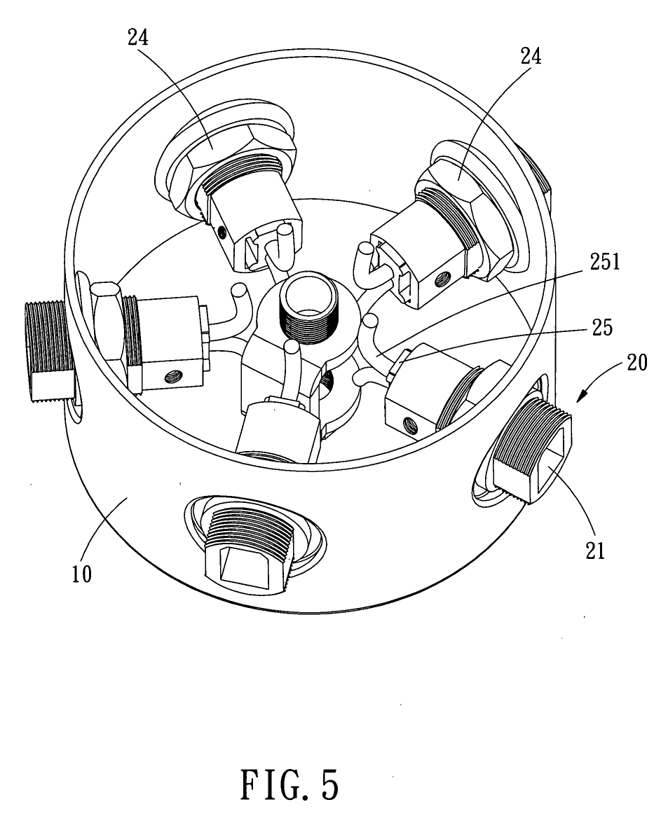

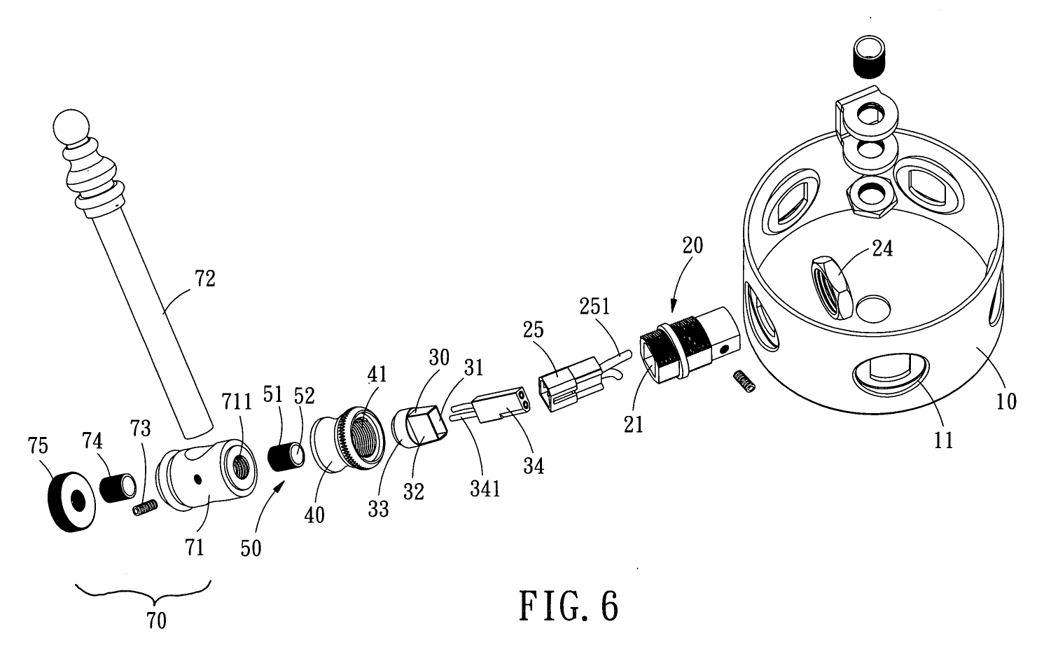

Referring to FIGS. 4-6, the lamp comprises a lamp body 10, a plurality of threaded mounting seats 20, a plurality of locking nuts 24, a plurality of female connectors 25, a plurality of threaded catch sleeves 40, a plurality of locating slides 30, a plurality of male connectors 34, a plurality of connecting members 50, and a plurality of lamp pole units 70. The lamp body 10 is formed with a plurality of mounting holes 11 for mounting the mounting seats 20. Each of the lamp pole units 70 includes a support seat 71 having an inside formed with a screw hole 711 which has a first portion screwed onto the second portion of the outer threading 51 of the connecting member 50, a pole 72 extended through and secured on the support seat 71, a threaded rod 74 having a first portion screwed into a second portion of the screw hole 711 of the support seat 71, and a threaded knob 75 screwed onto a second portion of the threaded rod 74. The pole 72 of each of the lamp pole units 70 is secured on the support seat 71 by a set screw 73. The second electric cords 341 of the male connector 34 are extended through the screw hole 711 of the support seat 71 of each of the lamp pole units 70.

As shown in FIG. 4, the lamp is a table lamp.

As shown in FIG. 4, the lamp is a pendant lamp.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lamp, comprising:
a lamp body;
at least one threaded mounting seat mounted on the lamp body;
at least one threaded catch sleeve screwed onto the mounting seat;
at least one locating slide limited between the mounting seat and the catch sleeve and movable relative to the mounting seat by rotation of the catch sleeve relative to the mounting seat;
at least one connecting member extended through the catch sleeve and having a first end secured to the locating slide and a second end protruding from the catch sleeve;
at least one lamp pole unit mounted on the second end of the connecting member.

2. The lamp in accordance with claim 1, further comprising:
at least one female connector mounted in the mounting seat;
at least one male connector mounted in the locating slide and movable by the locating slide to contact the female connector so that the male connector is electrically connected to the female connector.

3. The lamp in accordance with claim 2, wherein:
the mounting seat has an outer wall formed with an outer thread which has a first end formed with a first threaded portion protruding from a first side of the lamp body and a second end formed with a second threaded portion protruding from a second side of the lamp body;
the catch sleeve has an inside formed with a mounting bore which has a peripheral wall formed with an inner thread screwed onto the first threaded portion of the outer thread of the mounting seat so that the catch sleeve is rotatable relative to the mounting seat to push the locating slide to move relative to the mounting seat.

4. The lamp in accordance with claim 3, wherein the outer thread of the mounting seat has a mediate portion formed with a radially and outwardly extending limit flange located between the first threaded portion and the second threaded portion and rested on the first side of the lamp body.

5. The lamp in accordance with claim 4, further comprising at least one locking nut screwed onto the second threaded portion of the outer thread of the mounting seat and rested on the second side of the lamp body so that the lamp body is clamped between the limit flange of the mounting seat and the locking nut to secure the mounting seat to the lamp body.

6. The lamp in accordance with claim 1, wherein the locating slide is rotatable freely in the catch sleeve when the catch sleeve is rotatable relative to the mounting seat.

7. The lamp in accordance with claim 3, wherein:
the mounting seat has an inner wall formed with a receiving hole;
the locating slide has a first end formed with a locating post which is movable in the receiving hole of the mounting seat to move the male connector relative to the female connector and a second end formed with a column which is rotatable in the mounting bore of the catch sleeve when the catch sleeve is rotatable relative to the mounting seat.

8. The lamp in accordance with claim 7, wherein:
the female connector is mounted in the receiving hole of the mounting seat and provided with two first electric cords;
the locating slide has an inside formed with a receiving bore;
the male connector is mounted in the receiving bore of the locating slide to move with the locating slide and provided with two second electric cords that are electrically connected to the first electric cords of the female connector when the male connector is movable to contact the female connector.

9. The lamp in accordance with claim 8, wherein:
the column of the locating slide has an inside formed with a screw bore connected to the receiving bore and the mounting bore of the catch sleeve;
the connecting member has an outer wall formed with an outer threading having a first portion screwed into the screw bore of the column of the locating slide and a second portion protruded from the mounting bore of the catch sleeve.

10. The lamp in accordance with claim 9, wherein:
the connecting member is extended through the mounting bore of the catch sleeve and has an inner wall formed with a passage to allow passage of the second electric cords of the male connector;
the second electric cords of the male connector are extended through an inside of the lamp pole unit.

11. The lamp in accordance with claim 9, wherein the lamp pole unit has a first end formed with a screw hole screwed onto the second portion of the outer threading of the connecting member and a second end provided with a light source which is connected to the second electric cords of the male connector.

12. The lamp in accordance with claim 1, wherein the lamp body is formed with at least one mounting hole for mounting the mounting seat.

13. The lamp in accordance with claim 7, wherein the receiving hole of the mounting seat has a substantially rectangular shape and is extended through a whole length of the mounting seat.

14. The lamp in accordance with claim 3, wherein the mounting bore of the catch sleeve has substantially circular shape.

15. The lamp in accordance with claim 7, wherein the locating post of the locating slide has a substantially rectangular shape.

16. The lamp in accordance with claim 8, wherein the receiving bore of the locating slide is extended through a whole length of the locating slide.

17. The lamp in accordance with claim 9, wherein the lamp pole unit includes:
a support seat having an inside formed with a screw hole which has a first portion screwed onto the second portion of the outer threading of the connecting member;
a pole extended through and secured on the support seat;
a threaded rod having a first portion screwed into a second portion of the screw hole of the support seat;
a threaded knob screwed onto a second portion of the threaded rod.

18. The lamp in accordance with claim 17, wherein:
the pole of each of the lamp pole units is secured on the support seat by a set screw;
the second electric cords of the male connector are extended through the screw hole of the support seat of each of the lamp pole units.

19. The lamp in accordance with claim 3, wherein:
the locating slide is limited by the mounting bore of the catch sleeve so that the locating slide is movable with the catch sleeve;
the locating slide is rotatable in the mounting bore of the catch sleeve when the catch sleeve is rotatable relative to the mounting seat so that the locating slide is not rotatable with the catch sleeve when the catch sleeve is rotatable relative to the mounting seat;
the male connector is movable with the locating slide and is not rotatable with the catch sleeve;
the male connector is not rotatable relative to the female connector when the male connector is movable relative to the female connector.

20. The lamp in accordance with claim 3, wherein when the inner thread of the catch sleeve is screwed onto the first threaded portion of the outer thread of the mounting seat, the catch sleeve is rotatable relative to the mounting seat to push the locating slide toward the mounting seat and to move the male connector toward the female connector so that the male connector is electrically connected to the female connector.
